(19) United States
(12) Patent Application Publication
(10) Pub. No.: US 2005/0028777 A1
(43) Pub. Date: Feb. 10, 2005

(54) Fixing structure of intake manifold

(76) Inventor: Ill-Suk Yang, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,209

(22) Filed: Dec. 30, 2003

(30) Foreign Application Priority Data
Aug. 8, 2003 (KR) 10-2003-0055061

(51) Int. Cl. F02M 35/104

(52) U.S. Cl. 123/184.21; 123/184.46

(57) ABSTRACT

In accordance with one embodiment of the present invention, a fixing structure of an intake manifold comprises a boss part integrally formed with a throttle body mounting flange for being coupled to an engine block via a locking bolt, wherein the throttle body mounting flange is integrally coupled with the intake manifold. This contributes to a stabilization of an installation state of the intake manifold and improvement of the Noise, Vibration and Harshness (NVH) capability and life of the intake manifold.

### CROSS-REFERENCE TO RELATED APPLICATIONS

This application claims priority of Korean Application No. 10-2003-0055061, filed on Aug. 8, 2003, the disclosure of which is incorporated fully herein by reference.

### FIELD OF THE INVENTION

The present invention relates to a fixing structure of an intake manifold adapted to simply and stably support a portion where a load of the intake manifold is concentrated.

### BACKGROUND OF THE INVENTION

In general, an intake manifold integrally fabricated with a plurality of branch tubes attaches to the side of the cylinder head and is joined at one end to a surge tank and at the other end to a plurality of intake ports formed in the cylinder head.

The intake manifold is integrally formed with the surge tank in most cases, and the inlet of the surge tank is mounted with a throttle body to regulate the airflow entering the engine.

However, there is a drawback in intake manifolds integrally formed with surge tanks wherein the inlet of the surge tank is mounted with the throttle body in that the installation portion of the throttle body carries an excessively concentrated load.

### SUMMARY OF THE INVENTION

Embodiments of the present invention provide a fixing structure of an intake manifold for firmly securing and supporting an installation portion of a throttle body to an intake manifold integrally formed with a surge tank, thereby stabilizing the installation of the intake manifold.

In accordance with one embodiment of the present invention, a fixing structure of an intake manifold comprises a boss part integrally formed with a throttle body mounting flange for being coupled to an engine block via a locking bolt, wherein the throttle body mounting flange is integrally coupled with the intake manifold.

### BRIEF DESCRIPTION OF THE DRAWINGS

For a better understanding of the nature and objects of the present invention, reference should be made to the following detailed description with the accompanying drawings, in which:

FIG. 1 illustrates a fixing structure of an intake manifold according to the present invention; and

FIG. 2 illustrates the intake manifold of FIG. 1 installed in an engine according to the present invention.

### DETAILED DESCRIPTION OF THE PREFERRED EMBODIMENTS

The preferred embodiment of the present invention will now be described in detail with reference to the accompanying drawings.

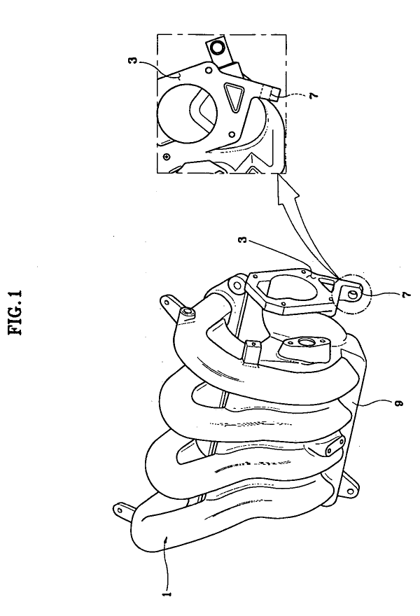

As shown in FIG. 1, a boss part 7 is integrally formed with a throttle body mounting flange 3 and configured to be coupled to an engine block by a locking bolt 5, wherein the throttle body mounting flange is integrally coupled to an intake manifold 1.

The intake manifold 1 is integrally formed with a surge tank 9, wherein the inlet part of the surge tank 9 is mounted with the throttle body mounting flange 3 for allowing a throttle body 11 to be attached thereto. The boss part 7 integrally formed with the throttle body mounting flange 3 is fastened by the locking bolt 5 to thereby firmly fix the intake manifold 1 to the engine.

By way of reference, the engine block in the embodiments of the present invention refers to either the cylinder block or the cylinder head.

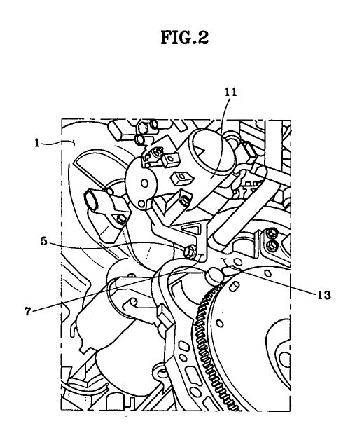

With reference to FIG. 2, a portion of the engine block contacting with the boss part 7 is a lateral side of a transmission mounting flange 13 of the rear cylinder block.

The portion of the engine block contacting with the boss part 7 has a relatively high rigidity as a structure for installing a transmission and also has a proper thickness for allowing a bolt hole of the locking bolt 5 to be formed thereon.

The boss part 7 protrudes out at the bottom of the throttle body mounting flange 3 toward the cylinder block and couples to a side of the transmission mounting flange 13.

FIG. 2 illustrates an embodiment of the present invention in detail, wherein the intake manifold 1 is mounted to the engine while the throttle body 11 is attached to the throttle body mounting flange 3.

When the throttle body 11 is installed as described above, the protruding boss part 7 at the bottom of the throttle body mounting flange 3 is tightly secured via the locking bolt 5 at the lateral side of the transmission mounting flange 13 such that the load-concentrated portion of the intake manifold 1 is tightly fastened to the cylinder block, and the overall state of the intake manifold 1 is stabilized at the engine.

The intake manifold 1 is, therefore, stabilized even in relation to various vibration and external forces applied to the intake manifold 1, thus the life of the intake manifold is increased and the Noise, Vibration and Harshness (NVH) capability is improved.

As apparent from the foregoing, there is an advantage in that the portion where the throttle body is installed to the intake manifold, which is integrally formed with the surge tank, is simply and firmly fixed by the boss part and the locking bolt, thereby obtaining a stable installation of the intake manifold, and improving the NVH capability and life of the intake manifold.

1. A fixing structure of an intake manifold, comprising a boss part integrally formed with a throttle body mounting flange configured to be coupled to an engine block via a locking bolt, said throttle body mounting flange being integrally coupled to an intake manifold.

2. The fixing structure as defined in claim 1, wherein a portion of said engine block contacting with said boss part is a lateral side of a transmission mounting flange of a rear cylinder block.

3. The fixing structure as defined in claim 1, wherein said boss part protrudes out at the bottom of said throttle body mounting flange toward said cylinder block.
